(19) United States
(12) Patent Application Publication
(10) Pub. No.: US 2026/0000984 A1
(43) Pub. Date: Jan. 1, 2026

(54) METHOD AND APPARATUS FOR CASTING TEAM TRANSFER SKILL, DEVICE, AND STORAGE MEDIUM

(71) Applicant: Tencent Technology (Shenzhen) Company Limited, Shenzhen (CN)

(72) Inventors: Linying XIE, Shenzhen (CN); Jiaqi PAN, Shenzhen (CN); Ying DENG, Shenzhen (CN); Weixiang YU, Shenzhen (CN); Wenyi LI, Shenzhen (CN); Yinglei WANG, Shenzhen (CN); Yun YANG, Shenzhen (CN); Zefeng YANG, Shenzhen (CN)

(21) Appl. No.: 19/318,295

(22) Filed: Sep. 3, 2025

Related U.S. Application Data
(63) Continuation of application No. PCT/CN2024/105961, filed on Jul. 17, 2024.

(30) Foreign Application Priority Data
Sep. 21, 2023 (CN) 202311226970.9

(51) Int. Cl. A63F 13/55; A63F 13/2145; A63F 13/52; A63F 13/533; A63F 13/822

(52) U.S. Cl. CPC A63F 13/55; A63F 13/52; A63F 13/533; A63F 13/822; A63F 13/2145

(57) ABSTRACT

A computer device performs a method for casting a team transfer skill. The method includes: displaying a first virtual character in a virtual environment; initiating a reminder control for the team transfer skill in response to a cast operation for the team transfer skill by a user of the computer device; transmitting reminder information to at least one teammate virtual character in response to a trigger operation for the reminder control, the reminder information being configured for reminding the at least one teammate virtual character to become a transfer target of the team transfer skill; and casting the team transfer skill to a second virtual character meeting a transfer condition of the team transfer skill, the second virtual character being a teammate virtual character that becomes the transfer target of the team transfer skill.

### CROSS-REFERENCE TO RELATED APPLICATIONS

This application is a continuation application of PCT Patent Application No. PCT/CN2024/105961, entitled “METHOD AND APPARATUS FOR CASTING TEAM TRANSFER SKILL, DEVICE, AND STORAGE MEDIUM” filed on Jul. 17, 2024, which claims priority to Chinese Patent Application No. 202311226970.9, entitled “METHOD AND APPARATUS FOR CASTING TEAM TRANSFER SKILL, DEVICE, AND STORAGE MEDIUM” filed on Sep. 21, 2023, both of which are incorporated by reference in their entirety.

### FIELD OF THE TECHNOLOGY

This application relates to the field of human-computer interaction, and in particular, to a method and apparatus for casting a team transfer skill, a device, and a storage medium.

### BACKGROUND OF THE DISCLOSURE

In a multiplayer battle game, some virtual characters can cast a team transfer skill for a teammate to perform tactical transfer, e.g., teleporting back to spring water or ascending to a certain height.

In a related technology, a game client displays a game interface on which a virtual character in a virtual environment and a skill button for a team transfer skill are displayed. After a player clicks/taps on the skill button, a casting waiting area for the team transfer skill is displayed in the virtual environment, and the team transfer skill is in a casting waiting state. The player performs in-game communication in a speech or text form via a universal social system to urge teammates to cooperate for this skill. The player manually triggers the casting of the team transfer skill after other players enter the casting waiting area. Alternatively, after a waiting duration reaches a preset duration, the casting of the team transfer skill is automatically triggered.

Since the aforementioned skill casting process relies on the universal social system, when the player has disabled the microphone and cannot use text chat, a skill casting failure often occurs.

### SUMMARY

This application provides a method and apparatus for casting a team transfer skill, a device, and a storage medium. The technical solutions are as follows:

According to one aspect of this application, provided is a method for casting a team transfer skill performed by a computer device and the method includes:
displaying a first virtual character in a virtual environment;
initiating a reminder control for the team transfer skill in response to a cast operation for the team transfer skill by a user of the computer device, wherein the team transfer skill enables the first virtual character to transfer an associated skill to a teammate virtual character;
transmitting reminder information to at least one teammate virtual character in response to a trigger operation for the reminder control, the reminder information being configured for reminding the at least one teammate virtual character to become a transfer target of the team transfer skill; and
casting the team transfer skill to a second virtual character meeting a transfer condition of the team transfer skill, the second virtual character being a teammate virtual character that becomes the transfer target of the team transfer skill.

According to another aspect, an embodiment of this application provides a computer device, including a processor and a memory, the memory having a computer program stored therein, and the computer program, when being loaded and executed by the processor, causing the computer device to implement the aforementioned method for casting a team transfer skill.

According to another aspect, an embodiment of this application provides a non-transitory computer-readable storage medium, having a computer program stored therein, the computer program, when executed by a processor of a computer device, causing the computer device to implement the aforementioned method for casting a team transfer skill.

The technical solutions provided in embodiments of this application produce at least the following beneficial effects:

After the team transfer skill is triggered, the reminder control for the team transfer skill is displayed. After the reminder control is triggered, the reminder information is transmitted to at least one teammate virtual character. Since the reminder control is a user interface (UI) control that can be quickly triggered by a player using a touch operation, a universal social system is not needed for reminding in a speech/text form. Even if the player has disabled the microphone or cannot type, quick communication with respect to the team transfer skill can be realized.

### BRIEF DESCRIPTION OF THE DRAWINGS

FIG. 1 illustrates a schematic diagram of a computer system provided by one embodiment of this application.

FIGS. 2A and 2B illustrate interface diagrams of a method for casting a team transfer skill provided by one embodiment of this application.

FIG. 3 illustrates a flowchart of a method for casting a team transfer skill provided by one embodiment of this application.

FIG. 4 illustrates a flowchart of a method for casting a team transfer skill provided by one embodiment of this application.

FIG. 5 illustrates an interface diagram of a method for casting a team transfer skill provided by one embodiment of this application.

FIG. 6 illustrates an interface diagram of a method for casting a team transfer skill provided by one embodiment of this application.

FIG. 7 illustrates an interface diagram of a method for casting a team transfer skill provided by one embodiment of this application.

FIG. 8 illustrates an interface diagram of a method for casting a team transfer skill provided by one embodiment of this application.

FIG. 9 illustrates an interface diagram of a method for casting a team transfer skill provided by one embodiment of this application.

FIG. 10 illustrates an interface diagram of a method for casting a team transfer skill provided by one embodiment of this application.

FIG. 11 illustrates a flowchart of a method for casting a team transfer skill provided by one embodiment of this application.

FIG. 12 illustrates an interface diagram of a method for casting a team transfer skill provided by one embodiment of this application.

FIG. 13 illustrates a flowchart of a method for casting a team transfer skill provided by one embodiment of this application.

FIG. 14 is a structural block diagram of an apparatus for casting a team transfer skill provided by one embodiment of this application.

FIG. 15 illustrates a structural block diagram of a computer device provided by one embodiment of this application.

### DESCRIPTION OF EMBODIMENTS

The terms used in this application are merely to describe the specific embodiments, instead of limiting this application. The singular forms of “a” and “the” used in this application and the appended claims are intended to include the plural forms as well, unless the context clearly indicates otherwise. Also, the term “and/or” used herein refers to and includes any of one or more of the associated listed items or all possible combinations.

In this application, before and during the collection of relevant data (such as video files in a terminal device and respective video fragments of the video files) of a user, a prompt interface or a pop-up window may be displayed, or voice prompt information may be outputted. The prompt interface, the pop-up window, or the voice prompt information is configured for prompting the user that relevant data of the user is currently being collected. In this way, in this application, only after a confirm operation performed by the user for the prompt interface or the pop-up window is obtained, the relevant operations of obtaining the relevant data of the user start to be performed. Otherwise (i.e., when no confirm operation is performed by the user for the prompt interface or the pop-up window is obtained), the relevant operations of obtaining the relevant data of the user are ended, i.e., the relevant data of the user is not obtained. In other words, all user data collected in this application are collected with the user's consent and authorization, and the collection, use, and processing of the relevant user data is required to comply with relevant laws, regulations, and standards in the relevant countries and regions.

First, relevant nouns involved in this application are explained below.

Virtual environment: A virtual environment displayed (or provided) when a client runs on a terminal. The virtual environment may be a simulated environment of the real world, a semi-simulated and semi-fictional environment, or a completely fictional environment. The virtual environment may be any one of a two-dimensional virtual environment, a 2.5-dimensional virtual environment, and a three-dimensional virtual environment. This is not limited in this application. The following embodiments are described by using an example in which the virtual environment is a three-dimensional virtual environment.

Although the terms such as “first” and “second” may be used in this application to describe various information, the information is not to be limited to these terms. These terms are merely used to distinguish between information of the same type. For example, without departing from the scope of this application, a first parameter may alternatively be referred to as a second parameter, and similarly, a second parameter may alternatively be referred to as a first parameter. Depending on the context, for example, the word “if” used herein may be interpreted as “while” or “when”, or “in response to determination”.

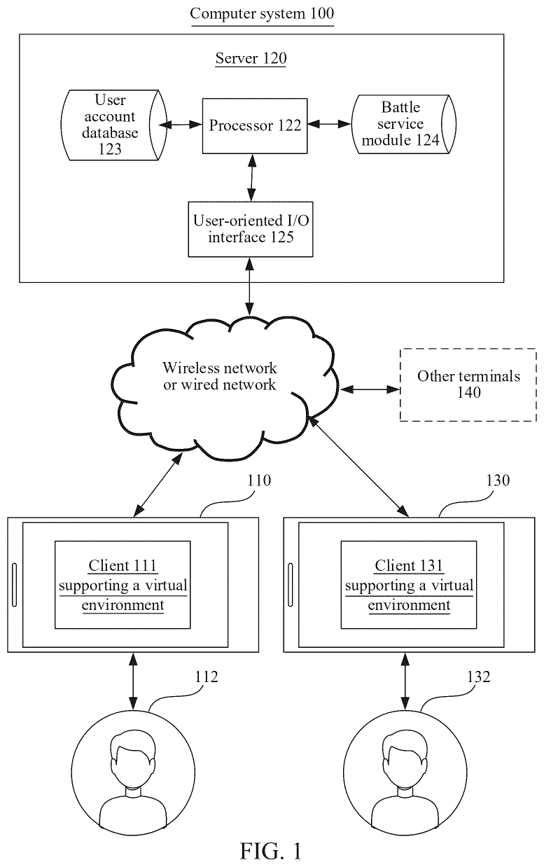

FIG. 1 illustrates a structural block diagram of a computer system provided by one embodiment of this application. The computer system 100 includes a first terminal 110, a server 120, and a second terminal 130.

A client 111 supporting a virtual environment is installed and runs on the first terminal 110. The client 111 may be a multiplayer online battle program. When the first terminal runs the client 111, a user interface of the client 111 is displayed on the screen of the first terminal 110. The client 111 may be any one of battle royale shooting games, virtual reality (VR) application programs, augmented reality (AR) programs, three-dimensional map programs, VR games, AR games, first-person shooting (FPS) games, third-person shooting (TPS) games, multiplayer online battle arena (MOBA) games, simulation games (SLGs), sandbox construction games, casual games, and level-based games. In this embodiment, the description is made by taking as an example that the client 111 is an FPS game. The first terminal 110 is a terminal used by a first user 112. The first user 112 uses the first terminal 110 to control a first virtual object in the virtual environment to perform an action. The first virtual object may be referred to as a virtual object of the first user 112. The action of the first virtual object includes, but is not limited to, at least one of moving, leaping, teleporting, casting a skill, using an item, adjusting a body posture, crawling, walking, running, riding, flying, jumping, driving, picking, shooting, attacking, and throwing. Exemplarily, the first virtual object is a simulated character or a cartoon character.

A client 131 supporting a virtual environment is installed and runs on the second terminal 130. The client 131 may be a multiplayer online battle program. When the second terminal 130 runs the client 131, a user interface of the client 131 is displayed on a screen of the second terminal 130. The client may be any one of battle royale shooting games, VR application programs, AR programs, three-dimensional map programs, VR games, AR games, FPS games, TPS games, MOBA games, and SLGs. In this embodiment, the description is made by taking as an example that the client is an MOBA game, The second terminal 130 is a terminal used by a second user 132. The second user 132 uses the second terminal 130 to control a second virtual object in the virtual environment to perform an action, and the second virtual object may be referred to as a virtual object of the second user 132. Exemplarily, the second virtual object is a simulated character or a cartoon character. In one embodiment, the first virtual object and the second virtual object are in the same virtual environment. In one embodiment, the first virtual object and the second virtual object may belong to a same camp, a same team, or a same organization, have a friend relationship, or have a temporary communication permission. In one embodiment, the first virtual object and the second virtual object may belong to different camps, different teams, or different organizations, or have an adversarial relationship. In one embodiment, the clients installed on the first terminal 110 and the second terminal 130 are the same, or the clients installed on the two terminals are the same type of clients on different operating system platforms (Android or IOS). The first terminal 110 may generally refer to one of a plurality of terminals, and the second terminal 130 may generally refer to another one of the plurality of terminals. In this embodiment, the description is made by only taking the first terminal 110 and the second terminal 130 as examples. The first terminal 110 and the second terminal 130 may be of a same device type or different device types. The device type includes at least one of a smartphone, a tablet computer, an e-book reader, an MP3 player, an MP4 player, a laptop computer, and a desktop computer.

FIG. 1 only shows two terminals. However, in different embodiments, there may be a plurality of other terminals 140 that can access the server 120. In one embodiment, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal 110 and the second terminal 130 may download the client installation package from the server 120 to update the client. The first terminal 110, the second terminal 130, and the other terminals 140 are connected to the server 120 through the wired or wireless network.

The server 120 includes at least one of one server, multiple servers, a cloud computing platform, and a virtualization center. The server 120 is configured to provide a background service for a client that supports a three-dimensional virtual environment. In one embodiment, the server 120 is in charge of primary computing works, and the terminal is in charge of secondary computing works. Alternatively, the server 120 is in charge of the secondary computing works, and the terminal is in charge of the primary computing works. Alternatively, the server 120 and the terminal perform collaborative computing by using a distributed computing architecture.

In an example, the server 120 includes a processor 122, a user account database 123, a battle service module 124, and a user-oriented input/output (I/O) interface 125. The processor 122 is configured to load instructions stored on the server 120, and process data in the user account database 123 and the battle service module 124. The user account database 123 is configured to store data of user accounts used by the first terminal 110, the second terminal 130, and another terminal 140, such as avatars of the user accounts, nicknames of the user accounts, fighting power indexes of the user accounts, and service areas of the user accounts. The battle service module 124 is configured to provide a plurality of battle rooms for users to battle, such as a 1V1 battle room, a 3V3 battle room, and a 5V5 battle room. The user-oriented I/O interface 125 is configured to establish communication with the first terminal 110 and/or the second terminal 130 via a wireless network or a wired network for data exchange. The method provided in this application may be applied to, but not limited to, at least one of the following scenarios: VR application programs, three-dimensional map programs, FPS games, TPS games, MOBA games, multiplayer gunfighting survival games, and the like. The following embodiments are described by taking the use in a game as an example.

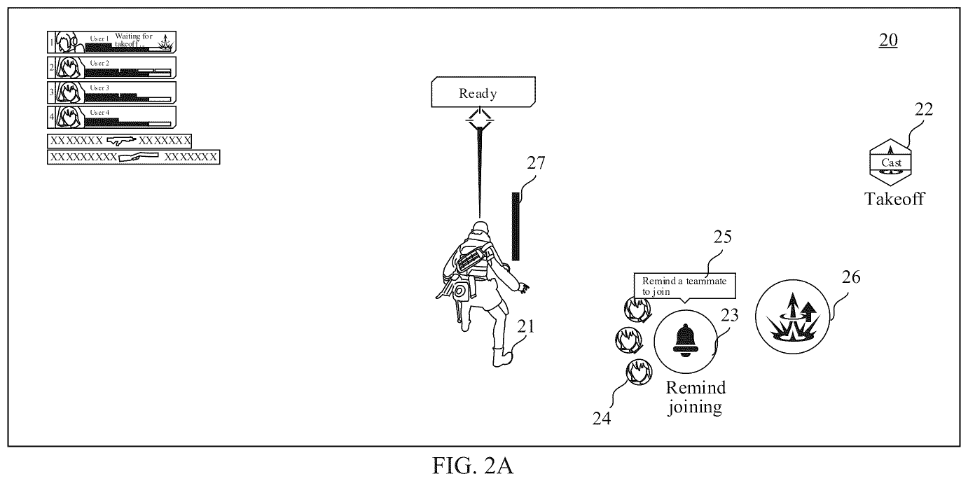

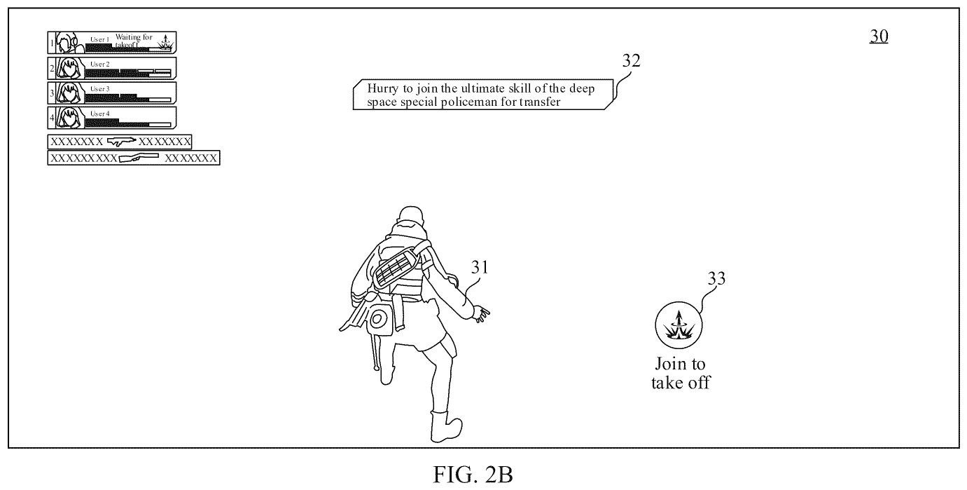

An embodiment of the present disclosure provides a quick reminder solution for a team transfer skill. Exemplarily, referring to FIGS. 2A and 2B, taking as an example that the team transfer skill is a group ascension skill, the current player and 4 teammates belong to the same team. A game interface 20 is displayed on a game client of the current player. The game interface 20 displays a player virtual character in a virtual environment: a deep space special policeman 21 having a team takeoff skill. The game interface 20 further displays a takeoff button 22 for the team takeoff skill. After clicking/tapping on the takeoff button 22, the current player enters a takeoff waiting state. The deep space special policeman 21 plays back an action of being preparing to take off. An energy bar 27 appears on the right side of the deep space special policeman 21, and gradually increases from 0% to 100% from its appearance. After the energy bar 27 reaches 100%, a skill state of the team takeoff skill changes to “ready”. After the takeoff button 22 is clicked/tapped, a join reminder button 23 may appear on the right side of the game interface 20. The join reminder button 23 includes the button body 23, 3 current surviving teammate avatars 24, and a text bubble “remind a teammate to join” 25 located at the top of the button body 23.

Whole-team reminder function: The current player clicks/taps on the button body 23, transmitting reminder information “Hurry to join the ultimate skill of the deep space special policeman for transfer” to all teammate virtual characters or all surviving teammate virtual characters. A surviving teammate virtual character is a teammate virtual character whose health points are not 0. If the teammate virtual character is dead, defeated, or in a to-be-revived state, the reminder information may not be transmitted.

Single teammate reminder function: The current player drags the button body 23 to a teammate avatar 24, or clicks/taps on a teammate avatar 24, transmitting the reminder information 32 “Hurry to join the ultimate skill of the deep space special policeman for transfer” to the teammate virtual character corresponding to the teammate avatar 24. The teammate virtual character is a virtual character controlled by a teammate. A game client of the teammate displays a game interface 30. A teammate virtual character 31 in a virtual environment is displayed on the game interface 30. After the teammate virtual character 31 receives the reminder information, “Hurry to join the ultimate skill of the deep space special policeman for transfer” is displayed on the game interface 30.

Moreover, the game interface 30 further displays a takeoff join button 33. After clicking/tapping on the takeoff join button 33, the teammate becomes a member for the team takeoff skill.

Furthermore, the teammate avatar 24 on the game interface 20 may have a plurality of display states:
Unjoined state: When the teammate virtual character does not become a member for the team takeoff skill, the teammate avatar 24 is displayed in the unjoined state. Exemplarily, the teammate avatar 24 in the unjoined state is displayed in gray.
Joined state: When the teammate virtual character becomes a member for the team takeoff skill, the teammate avatar 24 is displayed in the joined state. Exemplarily, the teammate avatar 24 in the joined state is displayed in color.

When the current player determines that the cast time is satisfied, for example, when all teammates have joined, the current player clicks/taps on a confirmation button 26 on the game interface 20 to enter a takeoff state.

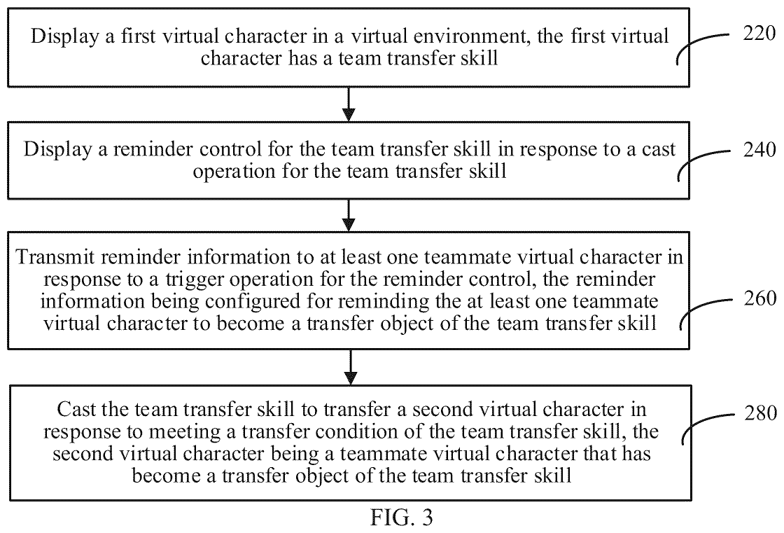

FIG. 3 illustrates a schematic diagram of a method for casting a team transfer skill provided by one embodiment of this application. The method is performed by a terminal device or a game client installed on a terminal, and the game client runs on the terminal device. The terminal device may be the terminal device shown in FIG. 1 and FIGS. 2A-2B. The method includes the following.

Operation 220: Display a first virtual character in a virtual environment. The first virtual character has the team transfer skill.

The game client runs on the terminal device and displays a game interface, and the game interface displays the first virtual character in the virtual environment.

The virtual environment is a virtual environment for a plurality of virtual characters to battle, and may be a two-dimensional virtual environment, a 2.5-dimensional virtual environment, or a three-dimensional virtual environment. The present embodiment is described by taking as an example that the virtual environment is the three-dimensional virtual environment.

The plurality of virtual characters are divided into at least two teams, each including at least two virtual characters. The first virtual character is a virtual character controlled by the current player. To be specific, a first account is logged into in the current game client, and the first virtual character is a virtual character for which the first account has control permission. The first virtual character belongs to a first team, and has one or more teammate virtual characters in the first team. The first virtual character has the team transfer skill. The team transfer skill has a capability of transferring at least one teammate virtual character to a specified location in the virtual environment; and/or the team transfer skill has a capability of transferring at least one teammate virtual character from the current location in the virtual environment to another location.

In some embodiments, the team transfer skill can be cast only when the first virtual character meets a casting precondition. Exemplarily, the casting precondition includes at least one of: a level of the first virtual character reaching a first threshold; a gold count of the first virtual character reaching a second threshold; energy of the first virtual character accumulating to a third threshold; and the first virtual character having the capability of casting the team transfer skill, or the first virtual character obtaining or carrying an item for casting the team transfer skill.

In some embodiments, a skill form of the team transfer skill may be any one of a teleportation skill, a blink skill, a stealth movement skill, an ascension skill, a rocket skill, a hot-air balloon skill, a speedboat skill, and the like.

In some embodiments, the first virtual character and the teammate virtual characters in the virtual environment are displayed on the game interface. In some embodiments, a cast control for the team transfer skill is also displayed on the game interface.

Operation 240: Display a reminder control for the team transfer skill in response to a cast operation for the team transfer skill.

The cast operation is an operation for triggering or activating the team transfer skill. In some embodiments, the cast operation is a human-computer interaction operation for the cast control, e.g., at least one of operations such as a single-click/tap operation, a double-click/tap operation, a long-press operation, an eye gazing operation, and a gesture operation. In some embodiments, the cast operation is an operation of pressing a specified key on a physical handle or a keyboard. In response to the cast operation for the team transfer skill, a joining waiting state for the team transfer skill is enabled. The joining waiting state is a state of waiting for a teammate virtual character to become a transfer target of the team transfer skill, and is also referred to as a pre-triggered state of waiting to perform team transfer. In different embodiments, the joining waiting state has different names, such as a waiting state, a charging state, and a takeoff waiting state, which will not be limited in the embodiments of this application. In response to the cast operation for the team transfer skill, the reminder control for the team transfer skill is also displayed. The reminder control is configured to trigger the reminding of one or more teammate virtual characters becoming transfer targets or members of, or joining a transfer process or a casting process or a casting range of the team transfer skill. The transfer target, the member, the transfer process, the casting process, and the casting range may be considered as an equivalent description.

Operation 260: Transmit reminder information to at least one teammate virtual character in response to a trigger operation for the reminder control. The reminder information is configured for reminding the at least one teammate virtual character to become the transfer target of the team transfer skill.

This operation may be implemented as at least one of the following operations:
Transmit the reminder information to all teammate virtual characters in response to a first trigger operation for the reminder control.
Transmit the reminder information to all teammate virtual characters meeting a join condition in response to a second trigger operation for the reminder control. The join condition includes, but is not limited to, at least one of: the teammate virtual character being in a survival state; a distance between the teammate virtual character and the first virtual character being less than a distance threshold; and an attribute of the teammate virtual character being lower than an attribute threshold. The attribute of the teammate virtual character being lower than the attribute threshold may be at least one of: health points of the teammate virtual character being less than a health point threshold, or magic points of the teammate virtual character being less than a magic threshold, or a remaining ammo count of the teammate virtual character being less than a count threshold.
Transmit the reminder information to at least one teammate virtual character indicated by a third trigger operation for the reminder control in response to the third trigger operation.

In one embodiment, the reminder information is presented on the game client corresponding to the teammate virtual character in at least one form of an on-screen reminder message, a voice message, and a vibration message.

Operation 280: Cast the team transfer skill to transfer a second virtual character in response to meeting a transfer condition of the team transfer skill. The second virtual character is a teammate virtual character that becomes the transfer target of the team transfer skill.

The transfer condition refers to a condition for the team transfer skill to start transfer. Exemplarily, the transfer condition includes, but is not limited to, at least one of:
receiving a transfer trigger operation for the team transfer skill;
a duration of the team transfer skill being in the joining waiting state reaching a preset duration; and
a total attribute value of the teammate virtual characters joining the team transfer skill reaching a preset quantity. The total attribute value includes at least one of a number of characters, a sum of character health points, a sum of character magic points, a sum of character volumes, and the like.

In some embodiments, after one or more teammate virtual characters become the transfer targets of the team transfer skill, the current player may manually trigger the team transfer skill to start transfer. In some embodiments, the game client may automatically trigger the team transfer skill to start transfer according to whether the transfer condition is met, for example, after one or more teammate virtual characters have joined the team transfer skill.

In conclusion, in the method provided in this embodiment, after the team transfer skill is triggered, the reminder control for the team transfer skill is displayed. After the reminder control is triggered, the reminder information is transmitted to at least one teammate virtual character. Since the reminder control is the UI control that can be quickly triggered by a player using a touch operation, a universal social system is not needed for reminding in a speech/text form. Even if the player has disabled the microphone or cannot type, quick communication with respect to the team transfer skill can be realized.

The aforementioned reminder control may be a combined control. The combined control is a control made up of a plurality of basic controls including a button control, a joystick control, a slide control, and the like. Exemplarily, the aforementioned reminder control includes a main reminder control and n teammate reminder controls. The main reminder control is configured to remind all teammate virtual characters or a plurality of teammate virtual characters. Each of the n teammate reminder controls is configured to remind one teammate virtual character.

Exemplarily, a reference is made to the following embodiment.

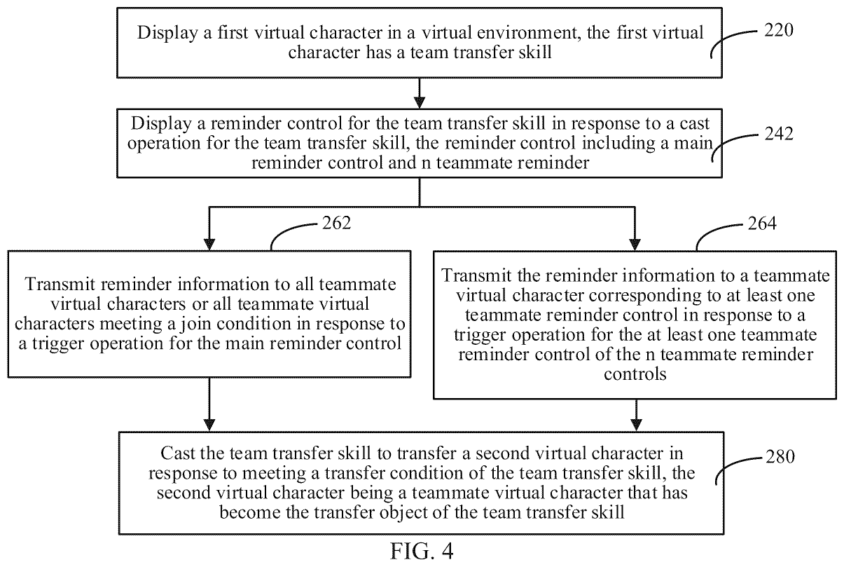

FIG. 4 illustrates a schematic diagram of a method for casting a team transfer skill provided by one embodiment of this application. The method is performed by a terminal device or a game client that runs on the terminal device. The terminal device may be the terminal device shown in FIG. 1 and FIGS. 2A-2B. The method includes the following.

Operation 220: Display a first virtual character in a virtual environment. The first virtual character has the team transfer skill.

The game client runs on the terminal device and displays a game interface, and the game interface displays the first virtual character in the virtual environment. In an example, a material file of the first virtual character in the virtual environment is stored by a terminal, and the rendering of the material file is performed by the terminal to display the first virtual character in the virtual environment. In another example, a background server of the game client performs the rendering of the material file, and transmits a display picture including the first virtual character to the terminal. The client installed on the terminal is configured to display the first virtual character, but does not perform the rendering process of the first virtual character.

The virtual environment is a virtual environment for a plurality of virtual characters to battle, and may be a two-dimensional virtual environment, a 2.5-dimensional virtual environment, or a three-dimensional virtual environment. The present embodiment is described by taking as an example that the virtual environment is the three-dimensional virtual environment.

The plurality of virtual characters are divided into at least two teams, each including at least two virtual characters. The first virtual character is a virtual character controlled by the current player. To be specific, a first account is logged into in the current game client, and the first virtual character is a virtual character for which the first account has control permission. The first virtual character belongs to a first team, and has one or more teammate virtual characters in the first team.

The first virtual character has the team transfer skill. The team transfer skill has a capability of transferring at least one teammate virtual character to a specified location in the virtual environment; and/or the team transfer skill has a capability of transferring at least one teammate virtual character from the current location in the virtual environment to another location.

In some embodiments, the team transfer skill can be cast only when the first virtual character meets a casting precondition. Exemplarily, the casting precondition includes at least one of: a level of the first virtual character reaching a first threshold; a gold count of the first virtual character reaching a second threshold; energy of the first virtual character accumulating to a third threshold; and the first virtual character gaining and possessing an item for or a capability of casting the team transfer skill.

In some embodiments, a skill form of the team transfer skill may be any one of a teleportation skill, a blink skill, a stealth movement skill, an ascension skill, a rocket skill, a hot-air balloon skill, a speedboat skill, and the like.

In some embodiments, the first virtual character and the teammate virtual characters in the virtual environment are displayed on the game interface. In some embodiments, a cast control for the team transfer skill is also displayed on the game interface.

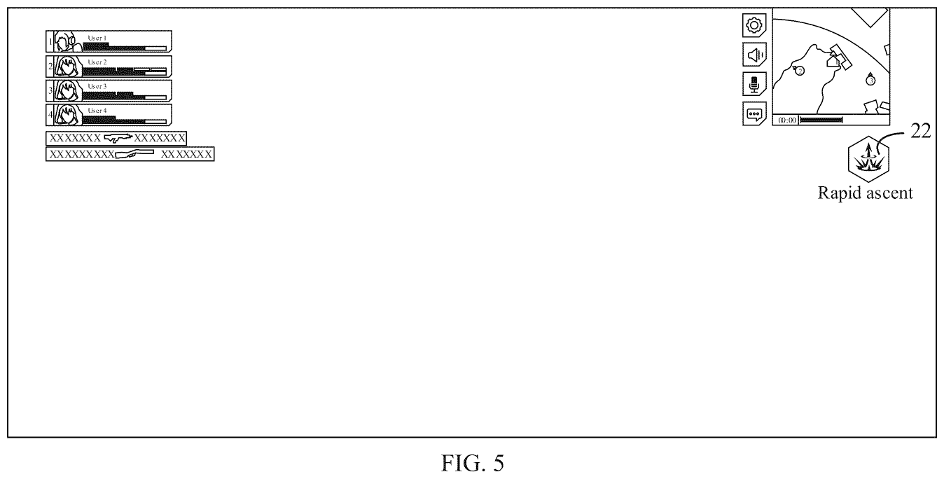

Exemplarily, referring to FIG. 5, the current player controls the first virtual character. When the team transfer skill of the first virtual character is available, a cast control 22 for the team transfer skill is displayed on the game interface. The cast control 22 is displayed in a clickable/tappable state, and words “Rapid ascent” are displayed on the cast control 22. FIG. 5 is described by taking as an example that the game client is a shooting game. In the shooting game, the game interface is displayed by default in the first-person perspective. However, in other types of games, the game interface may be displayed by default in the third-person perspective.

Operation 242: Display a reminder control for the team transfer skill in response to a cast operation for the team transfer skill. The reminder control includes a main reminder control and n teammate reminder controls, where n is a positive integer.

The cast operation is an operation for triggering or activating the team transfer skill. In some embodiments, the cast operation is a human-computer interaction operation for the cast control, e.g., at least one of operations such as a single-click/tap operation, a double-click/tap operation, a long-press operation, an eye gazing operation, and a gesture operation. In some embodiments, the cast operation is an operation of pressing a first specified key on a physical handle or a keyboard. The first specified key is a key corresponding to the team transfer skill.

In response to the cast operation for the team transfer skill, a joining waiting state for the team transfer skill is enabled. The joining waiting state is a state of waiting for a teammate virtual character to become a transfer target of the team transfer skill. In different embodiments, the joining waiting state has different names, such as a waiting state, a charging state, and a takeoff waiting state, which will not be limited in the embodiments of this application. In response to the cast operation for the team transfer skill, the reminder control for the team transfer skill is also displayed. The reminder control is configured to trigger the reminding of one or more teammate virtual characters becoming transfer targets or members of, or joining a transfer process or a casting process or a casting range of the team transfer skill. The transfer target, the member, the transfer process, the casting process, and the casting range may be considered as an equivalent description. In the embodiments of this application, the reminder control for the team transfer skill is displayed in response to the cast operation for the team transfer skill. In one example, in response to the cast operation for the team transfer skill, the terminal calls a material file of the reminder control, and incrementally displays the reminder control on the picture in which the first virtual character is displayed. In another example, the game client installed on the terminal reports the cast operation for the team transfer skill to the background server of the game client, and the server calls the material file of the reminder control, incrementally displays the reminder control on the picture in which the first virtual character is displayed, and transmits the picture including the reminder control to the client such that the client displays the picture.

In some embodiments, the reminder control is a combined control. The combined control has a plurality of trigger operations, and different trigger operations can trigger transmitting the reminder information to different teammate virtual characters.

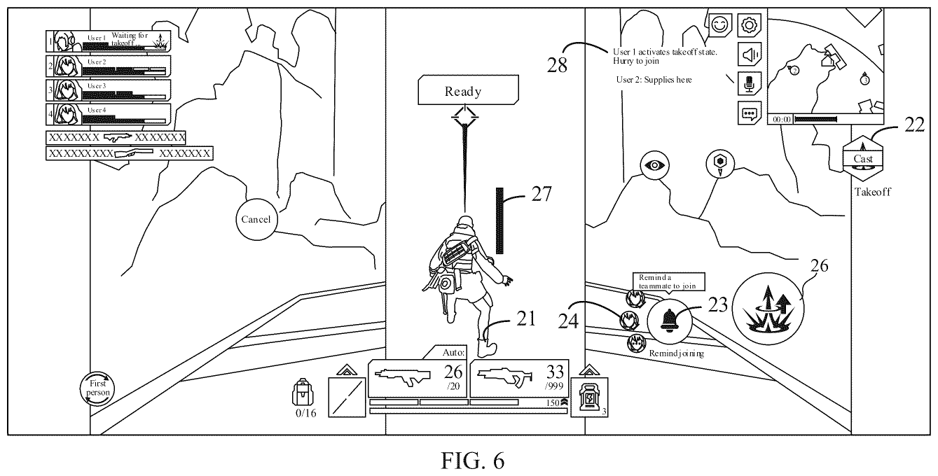

Exemplarily, referring to FIG. 6, the current player clicks/taps on the cast control 22 such that the first virtual character 21 enters the takeoff waiting state. In this case, the first-person perspective in FIG. 5 may be switched to the third-person perspective in FIG. 6 for displaying. The first virtual character 21 is displayed on the game interface. The first virtual character 21 plays back a flying action of being preparing to take off. In this case, a system message 28 is displayed in a team channel area of the game interface. A message content of the system message 28 is “user 1 activates the takeoff state. Join immediately”. Then, a takeoff aiming reticle is displayed on top of the head of the first virtual character 21, and an energy bar 27 is displayed on the right side, which gradually increases from 0% to 100% from its appearance. When the energy bar 27 has increased to 100%, the word “ready” is displayed around the takeoff aiming reticle. In addition, after the current player clicks/taps on the cast control 22, a reminder control is displayed in a right area of the game interface. The reminder control is a combined control. Exemplarily, the reminder control includes a main reminder control 23 and 3 teammate reminder controls 24. Each teammate reminder control 24 has identification information corresponding to the teammate virtual character. The identification information includes at least one of: an avatar of the teammate virtual character, a theme color corresponding to the teammate virtual character, an avatar frame corresponding to the teammate virtual character, and a sequence number corresponding to the teammate virtual character.

The main reminder control 23 is configured to trigger transmitting the reminder information to all teammate virtual characters or all teammate virtual characters meeting a join condition. The n teammate reminder controls 24 are configured to trigger transmitting the reminder information to at least one teammate virtual character.

In some embodiments, the method further includes: displaying the n teammate reminder controls 24 around the main reminder control 23 in a surrounding manner. In one embodiment, the n teammate reminder controls are displayed around the main reminder control in the surrounding manner according to a sorting order. The sorting order includes an order of sorting by character sequence numbers of the n teammate virtual characters. In a same virtual match, the teammate virtual characters have fixed character sequence numbers. When the controlling party of the first virtual character uses the team transfer skill a plurality of times, the position of the teammate reminder control corresponding to the teammate virtual character can be quickly determined according to the previous experience of using the team transfer skill.

Alternatively, the sorting order includes an order of sorting by distances between the n teammate virtual characters and the first virtual character. As the distance between the teammate virtual character and the first virtual character decreases, a degree to which the teammate virtual character and the first virtual character cooperate with each other in the virtual environment increases. Sorting by the distances between the n teammate virtual characters and the first virtual character helps the controlling party of the first virtual character quickly determine teammate virtual characters that cooperate with each other to perform a virtual battle in the virtual environment, so that the teammate virtual characters in a support relationship with the first virtual object can be quickly gathered and transferred to another location, thereby avoiding time consumption caused by movement of the teammate virtual characters in the support relationship to a location indicated by the team transfer skill.

Alternatively, the sorting order includes an order of sorting by attributes of the n teammate virtual characters. A lower attribute of a teammate virtual character (for example, a remaining ammo count mentioned above) indicates a lower virtual battle capability of the teammate virtual character in the virtual environment. Sorting by the attributes of the n teammate virtual characters helps the controlling party of the first virtual character quickly determine a teammate virtual character that needs to be transferred and that is in a weak position (i.e., has a low virtual battle capability), so as to help the teammate virtual character with the low virtual battle capability quickly get out of the current position, gather together with friendly virtual characters, obtain an opportunity of helping each other, or get away from a position where the virtual battle is hard and have a time for recovery.

Alternatively, the sorting order includes an order of sorting by degrees of intimacy between the n teammate virtual characters and the first virtual character. A higher degree of intimacy between a teammate virtual character and the first virtual character indicates a closer social relationship in the real world between the controlling parties of the teammate virtual character and the first virtual character, or a higher frequency of the controlling parties of the teammate virtual character and the first virtual character joining virtual matches. To be specific, there is a social relationship between both controlling parties in the application program providing the virtual environment. Sorting by the degrees of intimacy between the n teammate virtual characters and the first virtual character helps the controlling party of the first virtual character quickly determine whether a teammate virtual character has a close social relationship. It is convenient to maintain the social relationship between the controlling parties by quickly prompting a teammate virtual character having a high degree of intimacy to transfer.

Exemplarily, when the sorting order is the order of sorting by the character sequence numbers of the n teammate virtual characters/the order of sorting by the degrees of intimacy between the n teammate virtual characters and the first virtual character, the sorting order is transmitted to the client by the server in advance in the process of providing background support for a virtual battle. In a virtual battle, the teammate virtual characters have fixed character sequence numbers, or the degrees of intimacy between the n teammate virtual characters and the first virtual character are fixed in the current virtual battle. The server only needs to transmit the sorting order to the client once.

Exemplarily, if the sorting order includes the order of sorting by the distances between the n teammate virtual characters and the first virtual character/the order of sorting by the attributes of the n teammate virtual characters, the sorting order is obtained by the server through a query when the server responds to the cast operation for the team transfer skill, i.e., when the client has a need to display n teammate reminder controls, and is transmitted to the client. Exemplarily, the distances between the n teammate virtual characters and the first virtual character and the attributes of the n teammate virtual characters will change at different moments of a virtual battle. The sorting order obtained according to the aforementioned information is highly time-sensitive. The client transmits a query request to the server in response to the cast operation for the team transfer skill. The server obtains, through a query, the order of sorting by the distances between the n teammate virtual characters and the first virtual character/the order of sorting by the attributes of the n teammate virtual characters, and transmits the aforementioned sorting order to the client. The client is configured to display the n teammate reminder controls according to the aforementioned sorting order.

In some embodiments, each of the n teammate reminder controls 24 has a size smaller than a size of the main reminder control 23.

In some embodiments, the n teammate reminder controls 24 are in a one-to-one correspondence with teammate virtual characters in a player's team that meet a join condition. The join condition is a condition for becoming a transfer target of the team transfer skill. Exemplarily, the join condition includes at least one of the following.
The teammate virtual character is in a survival state. The teammate virtual character in the survival state is able to continue a virtual battle. When the join condition includes that the teammate virtual character is in the survival state, it can be ensured that the teammate virtual characters having the virtual battle capability gather after the team transfer is performed, so as to continue the virtual battle. It is realized that the teammate virtual characters having the virtual battle capability gather rapidly.
A distance between the teammate virtual character and the first virtual character is less than a distance threshold. When the distance between the teammate virtual character and the first virtual character is less than the distance threshold, the teammate virtual character and the first virtual character cooperate with each other (for example, assist in jointly performing a virtual attack, cover each other, or share a virtual resource with each other) in the virtual environment, and are teammate virtual characters in a support relationship with each other. When the join condition includes that the distance between the teammate virtual character and the first virtual character is less than the distance threshold, the teammate virtual characters in the support relationship with the first virtual object can be quickly gathered and transferred to another location, thereby avoiding time consumption caused by movement of the teammate virtual characters in the support relationship to a location indicated by the team transfer skill. Rapid movement of a batch of teammate virtual characters in the support relationship is realized.
An attribute of the teammate virtual character is lower than an attribute threshold. As described above, the attribute of the teammate virtual character being lower than the attribute threshold may be at least one of: the health points of the teammate virtual character being less than the health point threshold, or the magic points of the teammate virtual character being less than the magic threshold, or the remaining ammo count of the teammate virtual character being less than the count threshold. When the attribute of the teammate virtual character is lower than the attribute threshold, the teammate virtual character has low virtual battle capability in the virtual environment. When the join condition includes that the attribute of the teammate virtual character is lower than the attribute threshold, a batch of teammate virtual characters with low virtual battle capability can be transferred to the location indicated by the team transfer skill, so as to help the teammate virtual character with the low virtual battle capability quickly get out of the current position, gather together with friendly virtual characters, obtain an opportunity of helping each other, or get away from a position where the virtual battle is hard and have a time for recovery.

Since the number of the teammate virtual characters meeting the join condition dynamically changes, the value of n changes. Exemplarily, referring to FIG. 7, three cases in which N=1, 2, and 3 are respectively shown. When N=1, there is one teammate reminder control which is displayed at the center on the left side of the main reminder control. When N=2, there are two teammate reminder controls which are displayed on the left side of the main reminder control in such a manner of being evenly arranged up and down. When N=3, there are three teammate reminder controls which are displayed on the left side of the main reminder control in such a manner of being evenly arranged at top, middle, and bottom.

Each teammate reminder control displays an avatar of a teammate virtual character corresponding to the teammate reminder control.

Operation 262: Transmit the reminder information to all teammate virtual characters or all teammate virtual characters meeting the join condition in response to a trigger operation for the main reminder control.

The trigger operation is a human-computer interaction operation for the main reminder control, e.g., at least one of operations such as a single-click/tap operation, a double-click/tap operation, a long-press operation, an eye gazing operation, and a gesture operation. In some embodiments, the trigger operation is an operation for a second specified key on a physical handle or a keyboard. The second specified key is a key corresponding to the main reminder control, or a key corresponding to all teammate virtual characters or all teammate virtual characters meeting the join condition.

In the embodiments of this application, the client reports the trigger information for the reminder control (such as the main reminder control/at least one teammate reminder control) to the server. The trigger information is configured for indicating that the client has acquired the trigger operation, and carries a receiver of the reminder information indicated by the trigger operation. For example, the trigger operation acquired by the client is for the main reminder control, and the terminal determines that receivers of the reminder information corresponding to the trigger operation for the main reminder control are all teammate virtual characters or all teammate virtual characters meeting the join condition, and reports the receivers to the server. The trigger operation acquired by the client is for one teammate reminder control, and the terminal determines that a receiver of the reminder information corresponding to the trigger operation for the teammate reminder control is one teammate virtual character, and reports the receiver to the server. Exemplarily, when a virtual battle is started in the client, the server acquires identity information of virtual characters participating in the virtual battle, and divides the virtual characters in the virtual battle into at least two virtual camps to perform the virtual battle. The teammate virtual character is a virtual character belonging to the same virtual camp as the first virtual character. The server records the identity information of the teammate virtual characters of the first virtual character in the process of providing background support for the virtual battle, so as to transmit the reminder information to some or all of the teammate virtual characters. Exemplarily, the reminder information is configured for reminding at least one teammate virtual character to become the transfer target of the team transfer skill. The reminder information prompts the teammate virtual character in at least one form of a text, a symbol, an animation, and the like. Materials (such as texts, symbols, and animations) for constructing prompt information are pre-stored on the server.

By taking as an example that the trigger operation is a click/tap operation, the reminder information is transmitted to all teammate virtual characters or all teammate virtual characters meeting the join condition in response to the click/tap operation for the main reminder control. Exemplarily, whether the teammate virtual character meets the join condition is obtained by the server through a query. In one example, the join condition is only related to the state of the teammate virtual character itself, e.g., the teammate virtual character being in a survival state/the attribute of the teammate virtual character being lower than the attribute threshold as described above. In response to the trigger operation for the main reminder control, the client reports to the terminal the trigger information for the main reminder control. The trigger information always carries a request for querying for a teammate virtual character meeting the join condition. The server queries, based on the request, for attribute information/survival state of the teammate virtual characters in teammate virtual characters that belong to a same virtual camp of the first virtual character, and obtains the teammate virtual character that meets the join condition through selection.

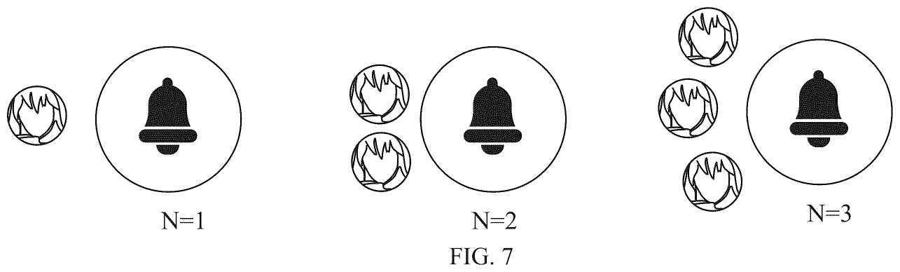

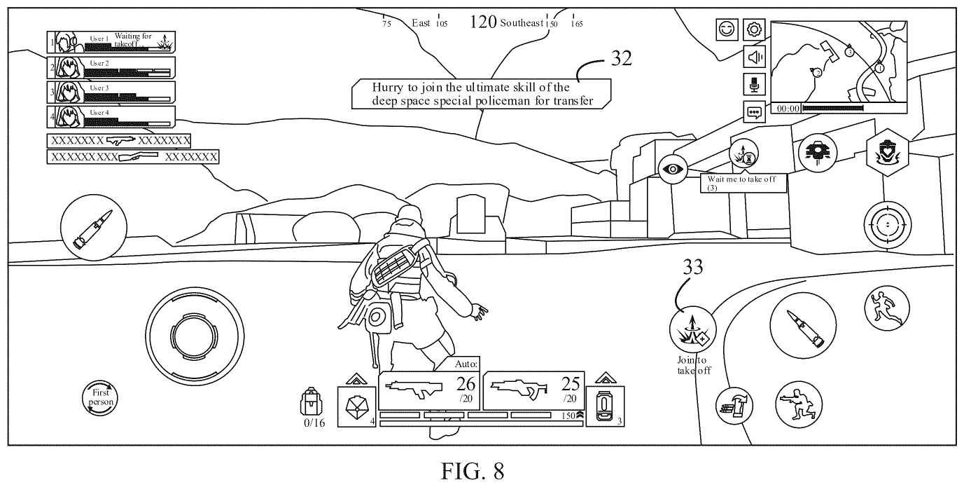

Exemplarily, as shown in FIG. 6, the reminder information is transmitted to all the teammate virtual characters meeting the join condition in response to the click/tap operation for the main reminder control 23. Referring to FIG. 8, the reminder information 32 is displayed on the game interfaces of these teammate virtual characters meeting the join condition. The information content of the reminder information 32 is “Hurry to join the ultimate skill of the deep space special policeman for transfer”.

Operation 264: Transmit the reminder information to a teammate virtual character corresponding to at least one teammate reminder control in response to a trigger operation for the at least one teammate reminder control of the n teammate reminder controls.

The trigger operation is a human-computer interaction operation for the at least one teammate reminder control, e.g., at least one of operations such as a single-click/tap operation, a double-click/tap operation, a long-press operation, an eye gazing operation, and a gesture operation. In some embodiments, the trigger operation is an operation for a third specified key on a physical handle or a keyboard. The third specified key is a key corresponding to a teammate reminder control or a teammate virtual character. In one embodiment, each teammate reminder control or teammate virtual character has a third specified key in a one-to-one correspondence with the teammate reminder control or teammate virtual character.

In some embodiments, taking as an example that the trigger operation is a click/tap operation, in response to a click/tap operation for at least one teammate reminder control of the n teammate reminder controls, the reminder information is transmitted to a teammate virtual character corresponding to the at least one teammate reminder control. To be specific, in some embodiments, the teammate reminder control is a button control and supports the click/tap operation by the user. When the user clicks/taps on a teammate reminder control, the reminder information is transmitted to the teammate virtual character corresponding to the teammate reminder control. In some embodiments, taking as an example that the trigger operation is a drag operation, in response to a drag operation of dragging the main reminder control onto at least one teammate reminder control of the n teammate reminder controls, the reminder information is transmitted to a teammate virtual character corresponding to the at least one teammate reminder control.

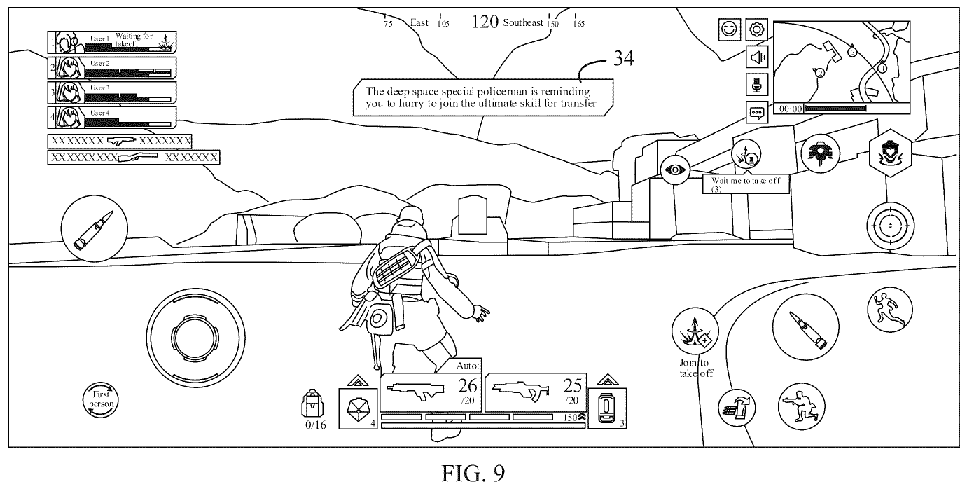

Taking as an example that the at least one teammate reminder control includes a first teammate reminder control, in response to a drag operation of dragging the main reminder control onto the first teammate reminder control, the reminder information is transmitted to the teammate virtual character corresponding to the first teammate reminder control when the main reminder control is dragged to overlap or to intersect with the first teammate reminder control. In one embodiment, the reminder information is the same as the reminder information in operation 262, or the reminder information is different from the reminder information in operation 262, and a prompt content specifically for the first teammate virtual character is present in the reminder information. Exemplarily, as shown in FIG. 9, the reminder information 34 includes: the deep space special policeman is reminding you to hurry to join the ultimate skill for transfer.

Taking as an example that the at least one teammate reminder control includes a first teammate reminder control and a second teammate reminder control, in response to a drag operation of sequentially dragging the main reminder control onto the first teammate reminder control and the second teammate reminder control, the reminder information is transmitted to the teammate virtual character corresponding to the first teammate reminder control and the teammate virtual character corresponding to the second teammate reminder control when the main reminder control is dragged to overlap or to intersect with the first teammate reminder control and the second teammate reminder control.

In some embodiments, referring to FIG. 8, a join control 33 is displayed on the game interface of the teammate virtual character, and in response to a trigger operation for the join control 33, the teammate virtual character becomes the transfer target of or joins the transfer range or the casting range of the team transfer skill. As an exemplary design, a control name “join to take off” is displayed on the join control 33. When the team transfer skill is in the joining waiting state, the join control 33 may be highlighted or displayed with a breathing light effect so as to guide a teammate to click/tap on the join control 33.

Operation 280: Cast the team transfer skill to transfer a second virtual character in response to meeting a transfer condition of the team transfer skill. The second virtual character is a teammate virtual character that becomes the transfer target of the team transfer skill.

The transfer condition refers to a condition for the team transfer skill to start transfer. Exemplarily, the transfer condition includes, but is not limited to, at least one of:
receiving a transfer trigger operation for the team transfer skill;
a duration of the team transfer skill being in the joining waiting state reaching a preset duration; and
a total attribute value of the teammate virtual characters joining the team transfer skill reaching a preset quantity. The total attribute value includes at least one of a number of characters, a sum of character health points, a sum of character magic points, a sum of character volumes, and the like.

In some embodiments, after one or more teammate virtual characters become the transfer targets of the team transfer skill, the current player may manually trigger the team transfer skill to start transfer. Exemplarily, referring to FIG. 6 which displays a confirmation button 26 for the team transfer skill, in response to a click/tap operation for the confirmation button 26, the first virtual character casts the team transfer skill to achieve team transfer of the first virtual character and the second virtual character. The second virtual character is a teammate virtual character that becomes the transfer target of the team transfer skill. In some embodiments, after one or more teammate virtual characters join the team transfer skill, the game client may automatically trigger the team transfer skill to start transfer. For example, a maximum waiting duration for the team transfer skill is 10 seconds. When the duration of the team transfer skill entering the joining waiting state reaches 10 seconds, regardless of whether a teammate virtual character becomes the transfer target of the team transfer skill, the team transfer skill is triggered to start team transfer. Exemplarily, in response to meeting the transfer condition of the team transfer skill, the client instructs the server to change the position of the second virtual character. Information about the change in the position of the second virtual character is synchronized to clients participating in a virtual battle via the server, ensuring that the position of the second virtual character has changed in the observation interfaces of the second virtual character and other virtual characters in the virtual battle.

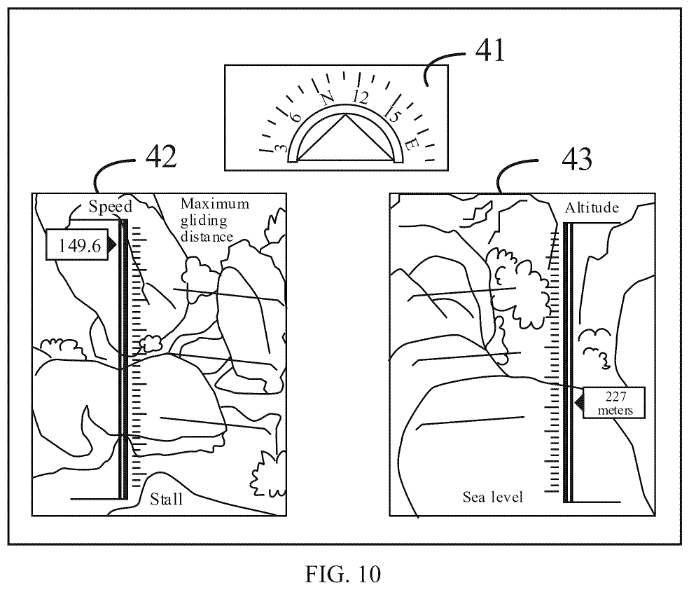

In some embodiments, taking as an example that the team transfer skill is the team takeoff skill, exemplarily, referring to FIG. 10, after the team transfer skill is cast, cast information of the team transfer skill is displayed on the game interface(s) corresponding to the first virtual character and/or the second virtual character. Exemplarily, the cast information includes at least one of the following three kinds of information:

flight heading angle information 41 configured for indicating a direction in which flight is being performed; flight speed information 42 configured for indicating a current flight speed; and flight altitude information 43 configured for indicating a current flight altitude. In one embodiment, the flight altitude is an altitude calculated based on a sea level in the virtual world. The flight altitude may be calculated in meters, e.g., 227 meters in the figure.

In conclusion, in the method provided in this embodiment, after the team transfer skill is triggered, the reminder control for the team transfer skill is displayed. After the reminder control is triggered, the reminder information is transmitted to at least one teammate virtual character. Since the reminder control is the UI control that can be quickly triggered by a player using a touch operation, a universal social system is not needed for reminding in a speech/text form. Even if the player has disabled the microphone or cannot type, quick communication with respect to the team transfer skill can be realized.

In the method provided in this embodiment, the main reminder control is provided, and the reminder information is transmitted to all teammate virtual characters or all teammate virtual characters in the survival state in response to the trigger operation for the main reminder control, so that a quick multi-person reminder function can be realized. In the method provided in this embodiment, n teammate reminder controls are provided, and the reminder information is transmitted to a teammate virtual character corresponding to at least one teammate reminder control in response to the trigger operation for the at least one teammate reminder control, so that a quick targeted single-person or some-person reminder function can be realized.

In some embodiments, the teammate reminder control has at least two display states. Different display states are configured for indicating the states of the teammate virtual character. The at least two display states include, but are not limited to, at least two of:
a first state configured for indicating that the teammate virtual character has not become the transfer target of the team transfer skill yet; a second state configured for indicating that the teammate virtual character becomes the transfer target of the team transfer skill; a third state configured for indicating that the teammate virtual character has not been reminded yet; and a fourth state configured for indicating that the teammate virtual character has been reminded.

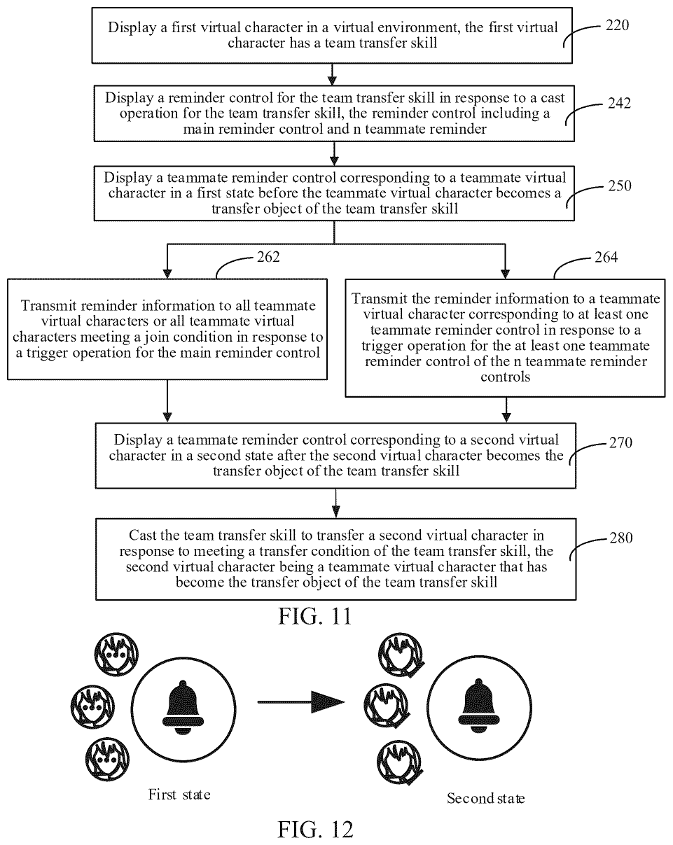

Exemplarily, referring to FIG. 11, taking an example that the teammate reminder control includes a first state and a second state, the method further includes the following operations.

Operation 250: Display the teammate reminder control corresponding to the teammate virtual character in the first state before the teammate virtual character becomes the transfer target of the team transfer skill.

Before the teammate virtual character becomes the transfer target of the team transfer skill, the teammate virtual character has not become the transfer target of the team transfer skill yet, and the teammate reminder control corresponding to the teammate virtual character is displayed in the first state.

In one embodiment, the first state includes that the teammate reminder control is displayed in a first color and a first icon is overlaid on the teammate reminder control. For example, the first icon is “ . . . ”, as shown in FIG. 12.

Operation 270: Display the teammate reminder control corresponding to the second virtual character in the second state after the second virtual character becomes the transfer target of the team transfer skill.

After the second virtual character becomes the transfer target of the team transfer skill, the second virtual character becomes the transfer target of the team transfer skill yet, and the teammate reminder control corresponding to the second virtual character is displayed in the second state.

In one embodiment, the second state includes that the teammate reminder control is displayed in a second color and a second icon is overlaid on the teammate reminder control. For example, the second icon is “V” at the lower right corner, as shown in FIG. 12.

In conclusion, in the method provided in this embodiment, different display states are provided for the teammate reminder control so that the teammate reminder control has an additional information providing function. When the method is applied to a mobile terminal, more diversified information can be displayed on a limited screen in a relatively small occupied area.

In some embodiments, the main reminder control supports two operations: a click/tap operation and a drag operation. To avoid a false touch by the user, the main reminder control is set to an undraggable state by default. The method further includes the following operation prior to operation 262:

Switch the main reminder control from the undraggable state to a draggable state in response to a dragging trigger operation for the main reminder control.

When in the undraggable state, the main reminder control supports only the click/tap operation and does not support the drag operation. When in the draggable state, the main reminder control supports only the drag operation and does not support the click/tap operation.

The dragging trigger operation is a trigger operation configured for switching the main reminder control from the undraggable state to the draggable state. In one embodiment, the dragging trigger operation is a long-press operation.

In some embodiments, the main reminder control is switched from the draggable state to the undraggable state in response to a trigger cancel operation for the main reminder control.

In one example, the main reminder control in the undraggable state corresponds to a first material file, and rendering is performed on the first material file to obtain the main reminder control in the undraggable state. In response to the dragging trigger operation for the main reminder control, the client alters the material file of the main reminder control from the first material file to a second material file. The second material file is rendered to obtain the main reminder control in the draggable state. For example, a wheel disc portion and a joystick portion are provided to support the dragging of the main reminder control. Exemplarily, the main reminder control may have a same appearance style or different appearance styles in the undraggable state and in the draggable state. Trigger logic for the main reminder control in the two states are different to implement the movement (for example, dragging onto at least one teammate reminder control of the n teammate reminder controls) of the main reminder control in the draggable state and the triggering of a click/tap operation for the main reminder control in the undraggable state.

In one embodiment, the trigger cancel operation is a long-press end operation or a long-press cancel operation corresponding to the aforementioned long-press operation.

In some embodiments, in response to the dragging trigger operation for the main reminder control, the size of the main reminder control will be further adjusted to be equal to or smaller than the size of each of the n teammate reminder controls. Because in a default state, the size of the main reminder control is greater than the size of each of the n teammate reminder controls, it is easy to cover a plurality of teammate reminder controls at the same time by dragging the main reminder control. To avoid a misoperation, in response to the dragging trigger operation for the main reminder control, the size of the main reminder control is reduced, while the size of each of the n teammate reminder controls is kept unchanged or increased. Alternatively, in response to the dragging trigger operation for the main reminder control, the size of the main reminder control is kept unchanged, while the size of each of the n teammate reminder controls is increased until the size of the main reminder control is equal to or smaller than the size of each of the n teammate reminder controls.

In this case, the user can drag the main reminder control to cover a teammate reminder control precisely, thereby avoiding a false touch.

Taking as an example that the aforementioned virtual character is a hero, when the current player selects a hero with the team transfer skill in a game battle, from a time point at which the game battle starts or the last use ends, the energy of the team transfer skill increases at a fixed increase rate x. The game client periodically detects whether the skill recharging energy reaches 100%? When the skill recharging energy increases to 100%, the button of the team transfer skill changes from a disabled state to an interactive state. When the skill recharging energy does not increase to 100%, next detection is waited. After it is recognized that the player clicks/taps on the button of the team transfer skill, the following effects are enabled: 1. The perspective is changed to the third-person perspective, and the takeoff action of the hero is played back. 2. An interface map that is exclusive to the hero and that represents a flight state is displayed. 3. An energy bar appears on the right side of the reticle, counting down starts from its appearance, and the energy bar increases from 0% to 100% at a fixed increase rate y. 4. After the skill button is clicked/tapped, its state changes to preparing, and a cancel button for canceling skill casting appears on the left side of the reticle. 5. In the status bar of a regular UI control at the upper left corner, the character status of the hero of the player changes to: waiting for takeoff. 6. Teammate joining information and the reminder control appear on the left side of the cast button at the lower right corner. The teammate joining information and the reminder control include 2 parts: Join reminder button and Teammate join state display. The join reminder button includes a button, an icon, and a text. When the join reminder button appears, a bubble “remind a teammate to join” appears at the top, and disappears after it appears and is displayed for 5s. At the casting moment, the game client of the current player needs to request four pieces of instant information from the server: the number n of surviving teammates, the teammate numbers a1 to an, the teammate color values b1 to bn of the surviving teammates, and hero numbers c1 to cn selected by the surviving teammates. After the four pieces of data are obtained, n teammate reminder components are displayed in a vertical arrangement on the left side, which include the teammate color values b1 to bn displayed in the edge circle, and picture materials corresponding to the teammate hero numbers c1 to cn displayed in the center.

In addition, the game client of the current player further needs to request a piece of information from the server in real time: whether the surviving teammates a1 to an currently join the ultimate skills y1 to yn (Yes/No). Initial states of this group of values are No, and correspondingly, material map “ . . . ” is displayed. When it is obtained in real time that yn is switched to Yes, the displayed material is switched to map “✓”. After the skill is casted, the join reminder button needs to read two operations in real time: a click/tap operation or a drag operation. After the click/tap operation is recognized, the reminder information is immediately uploaded to the game client, and the game client transmits global information “Hurry to join the ultimate skill of the deep space special policeman for transfer” to all surviving teammates. After the drag operation is recognized, it is determined whether an end point of the dragged button belongs to an area of the teammate reminder components a1 to an. If yes, the teammate number an is recorded, and the reminder information is uploaded to the server. The server transmits the reminder information to the game client of the teammate an such that the game client of the teammate an displays “The deep space special policeman is reminding you to hurry to join the ultimate skill for transfer” and plays back a hero voice reminder z.

After the click/tap operation is recognized on the skill cast button, the skill is casted, while entering a next-stage skill state: takeoff. Alternatively, after the click/tap operation is recognized on the skill cancel button, the skill is canceled, while returning to the state before casting.

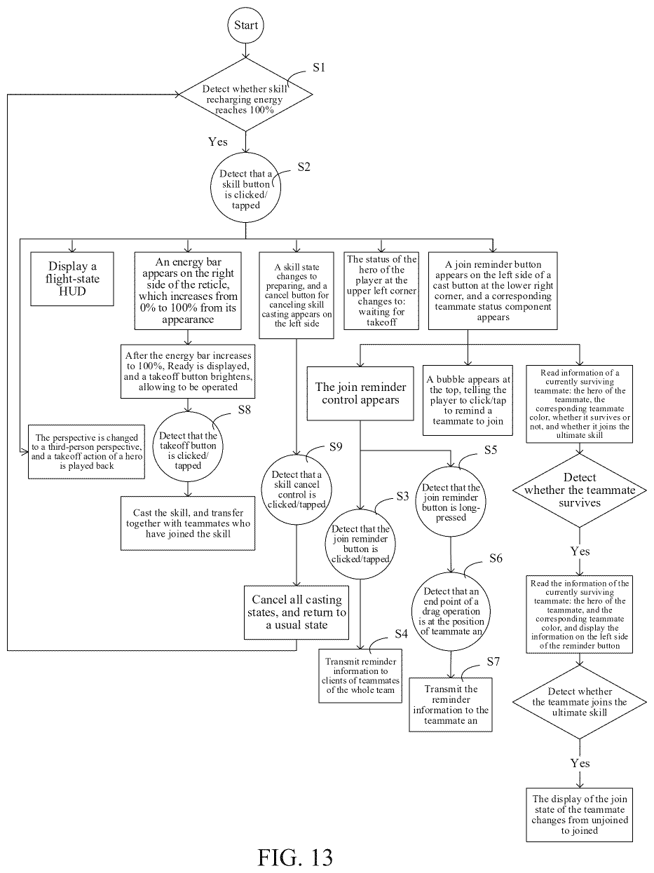

Exemplarily, referring to FIG. 13, the foregoing process includes the following.

S1: Detect whether the skill recharging energy reaches 100%.

When the current player selects the hero in the battle, from the start of the battle, the energy of the ultimate skill increases at the fixed increase rate x, and when the energy increases to 100%, the button of the ultimate skill changes from the disabled state to the interactive state. The game client periodically determines the state of the skill button.

S2: Detect that the skill button is clicked/tapped.

A click/tap gesture is detected when the skill state is ready. When the click/tap gesture is detected, a skill preparing state is enabled.

After the skill preparing state is enabled, the following effects are enabled: 1. The perspective is changed to the third-person perspective, and the takeoff action of the character is played back. 2. An interface map that is exclusive to the hero and that represents a flight state is displayed. 3. An energy bar appears on the right side of the reticle, counting down starts from its appearance, and the energy bar increases from 0% to 100% at a fixed increase rate y. 4. After the skill button is clicked/tapped, its state changes to preparing, and a cancel button for canceling skill casting appears on the left side of the reticle. 5. In the teammate status bar of the regular UI control at the upper left corner, the character status of the player changes to: waiting for takeoff. 6. Teammate joining information and the join reminder button appear on the left side of the cast button at the lower right corner.

As displayed by the join reminder button, the join reminder button includes a button, an icon, and a text. When the join reminder button appears, a bubble “remind a teammate to join” appears at the top, and disappears after it appears and is displayed for 5s.

As displayed by the teammate join state control, at the casting waiting stage, the game client of the current player needs to request four pieces of instant information from the server: the number n of surviving teammates, the teammate numbers a1 to an, the teammate color values b1 to bn of the surviving teammates, and hero numbers c1 to cn selected by the surviving teammates. After the four pieces of data are obtained, n teammate components are displayed in a vertical arrangement on the left side, which include the teammate color values b1 to bn displayed in the edge circle, and picture materials corresponding to the teammate hero numbers c1 to cn displayed in the center. In addition, a piece of information needs to be requested from the server in real time: whether the surviving teammates a1 to a currently join the ultimate skills y1 to yn (Yes/No). Initial states of this group of values are No, and correspondingly, material map “ . . . ” is displayed. When it is obtained in real time that yn is switched to Yes, the displayed material is switched to map “✓”.

S3: Detect that the join reminder button is clicked/tapped.

The reminder information is immediately uploaded to the game client after the click/tap operation for the join reminder button is recognized.

S4: Transmit the reminder information to clients of teammates of the whole team.

The game client of the current player transmits the global information “Hurry to join the ultimate skill of the deep space special policeman for transfer” to the game clients of all surviving teammates.

S5: Detect that the join reminder button is long-pressed.

The join reminder button is switched to the draggable state.

S6: Detect that the end point of the drag operation is at the position of the teammate an.

After the drag operation for the join reminder button is recognized, whether the end point of the drag operation belongs to the area of the components of the teammates a1 to an. If yes, the teammate number an is recorded, and the reminder information is uploaded to the server.

S7: Transmit the reminder information to the teammate an.

The server transmits the reminder information to the game client of the specified teammate an, such that the game client of the teammate an displays “The deep space special policeman is reminding you to hurry to join the ultimate skill for transfer” and plays back the hero voice reminder.

S8: Detect that a takeoff button is clicked/tapped.

After the click/tap operation is recognized on the skill cast button, namely the takeoff button, the team transfer skill is cast, while entering a next-stage skill state: team takeoff.

S9: Detect that a skill cancel control is clicked/tapped.

After the click/tap operation is recognized on the skill cancel button, the team transfer skill is canceled, while returning to the state before casting.

In an application scenario of this application, the application program providing a virtual environment is a shooting game application program, and the team transfer skill is that a first virtual character in the shooting game application program obtains or carries an item for casting the team transfer skill. Correspondingly:
The first virtual character in the virtual environment is displayed. The first virtual character obtains or carries a first item for casting the team transfer skill.
A reminder control for the team transfer skill casted by the first item is displayed in response to a cast operation for the first item.

In one embodiment, the reminder control includes n teammate reminder controls that are in a one-to-one correspondence with n teammate virtual characters, where n is a positive integer. This operation may be implemented as: in response to a trigger operation for at least one teammate reminder control of the n teammate reminder controls, transmitting the reminder information to a teammate virtual character corresponding to the at least one teammate reminder control.

Further, in one embodiment, the reminder control also includes a main reminder control.

As described above, the in response to the trigger operation for at least one teammate reminder control of the n teammate reminder controls, transmitting the reminder information to the teammate virtual character corresponding to the at least one teammate reminder control includes:

transmitting the reminder information to the teammate virtual character corresponding to the at least one teammate reminder control in response to a drag operation of dragging the main reminder control onto at least one teammate reminder control of the n teammate reminder controls.

In an implementation, before the in response to the drag operation of dragging the main reminder control onto at least one teammate reminder control of the n teammate reminder controls, transmitting the reminder information to the teammate virtual character corresponding to the at least one teammate reminder control, the method further includes: switching the main reminder control from an undraggable state to a draggable state in response to a dragging trigger operation for the main reminder control.

In an implementation, the reminder control further includes a main reminder control.

As described above, the in response to the trigger operation for at least one teammate reminder control of the n teammate reminder controls, transmitting the reminder information to the teammate virtual character corresponding to the at least one teammate reminder control includes:
transmitting the reminder information to all teammate virtual characters in response to a trigger operation for the main reminder control;
or transmitting the reminder information to all teammate virtual characters meeting a join condition in response to a trigger operation for the main reminder control. The join condition includes at least one of: the teammate virtual character being in a survival state; a distance between the teammate virtual character and the first virtual character being less than a distance threshold; and an attribute of the teammate virtual character being lower than an attribute threshold.
The reminder information is transmitted to at least one teammate virtual character in response to the trigger operation for the reminder control. The reminder information is configured for reminding the at least one teammate virtual character to become a transfer target of the team transfer skill.
The team transfer skill is cast to transfer a second virtual character in response to meeting a transfer condition of the team transfer skill. The second virtual character is a teammate virtual character that becomes the transfer target of the team transfer skill.

In one example, the first item is pre-assembled by the first virtual character before participating in a virtual battle. To be specific, the first item is carried by the first virtual character in advance before participating in the virtual battle. In another example, the first item is picked up by the first virtual character in the virtual environment of a virtual battle. To be specific, the first item is immediately used after being picked up by the first virtual character in the virtual environment, or is carried after being picked up in the virtual environment.

In another application scenario of this application, the application program providing the virtual environment is a simulation game (SLG). Further, the application program is, for example, a multiplayer online battle arena (MOBA) game. The team transfer skill is a skill the first virtual character is equipped with/a preset inherent skill. In one example, the first virtual character possesses three virtual skills, which are referred to as a first skill, a second skill, and a third skill (also referred to as an ultimate skill). The team transfer skill is any one of the foregoing three skills. Correspondingly:
The first virtual character in the virtual environment is displayed. The first virtual character possesses the capability of casting the team transfer skill.
A reminder control for the team transfer skill casted by the first item is displayed in response to a cast operation for casting the team transfer skill the first virtual character possesses.

In one embodiment, the reminder control includes n teammate reminder controls that are in a one-to-one correspondence with n teammate virtual characters, where n is a positive integer. This operation may be implemented as: in response to a trigger operation for at least one teammate reminder control of the n teammate reminder controls, transmitting the reminder information to a teammate virtual character corresponding to the at least one teammate reminder control.

Further, in one embodiment, the reminder control also includes a main reminder control.

As described above, the in response to the trigger operation for at least one teammate reminder control of the n teammate reminder controls, transmitting the reminder information to the teammate virtual character corresponding to the at least one teammate reminder control includes:
transmitting the reminder information to the teammate virtual character corresponding to at least one teammate reminder control in response to a drag operation of dragging the main reminder control onto the at least one teammate reminder control of the n teammate reminder controls.

In an implementation, before the in response to the drag operation of dragging the main reminder control onto at least one teammate reminder control of the n teammate reminder controls, transmitting the reminder information to the teammate virtual character corresponding to the at least one teammate reminder control, the method further includes: switching the main reminder control from an undraggable state to a draggable state in response to a dragging trigger operation for the main reminder control.

In an implementation, the reminder control further includes a main reminder control.

As described above, the in response to the trigger operation for at least one teammate reminder control of the n teammate reminder controls, transmitting the reminder information to the teammate virtual character corresponding to the at least one teammate reminder control includes:
transmitting the reminder information to all teammate virtual characters in response to a trigger operation for the main reminder control;
or transmitting the reminder information to all teammate virtual characters meeting a join condition in response to a trigger operation for the main reminder control. The join condition includes at least one of: the teammate virtual character being in a survival state; a distance between the teammate virtual character and the first virtual character being less than a distance threshold; and an attribute of the teammate virtual character being lower than an attribute threshold.
The reminder information is transmitted to at least one teammate virtual character in response to the trigger operation for the reminder control. The reminder information is configured for reminding the at least one teammate virtual character to become a transfer target of the team transfer skill.
The team transfer skill is cast to transfer a second virtual character in response to meeting a transfer condition of the team transfer skill. The second virtual character is a teammate virtual character that becomes the transfer target of the team transfer skill.

The following describes apparatus embodiments of this application, which can be configured for executing the method embodiments of this application. For details not disclosed in the apparatus embodiments of this application, a reference is made to the method embodiments of this application.

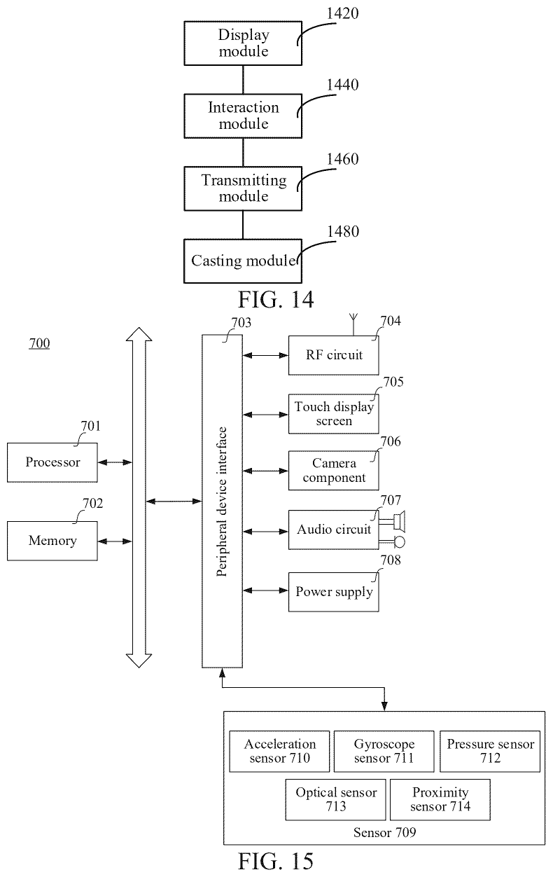

FIG. 14 illustrates a structural block diagram of an apparatus for casting a team transfer skill provided by one embodiment of this application. The apparatus has the functionality of implementing the foregoing examples of the method for casting a team transfer skill, and the functionality may be implemented by hardware or may be implemented by hardware executing corresponding software. As shown in FIG. 14, the apparatus may include:
a display module 1420 configured to perform operation 220 in the embodiment of FIG. 3; an interaction module 1440 configured to perform operation 240 in the embodiment of FIG. 3; a transmitting module 1460 configured to perform operation 260 in the embodiment of FIG. 3; and a casting module 1480 configured to perform operation 280 in the embodiment of FIG. 3.

In some embodiments, the reminder control includes n teammate reminder controls that are in a one-to-one correspondence with n teammate virtual characters, where n is a positive integer.

The transmitting module 1460 is configured to perform operation 264 in the embodiment of FIG. 4.

In some embodiments, the reminder control further includes a main reminder control.

The transmitting module 1460 is configured to transmit the reminder information to the teammate virtual character corresponding to at least one teammate reminder control in response to a drag operation of dragging the main reminder control onto the at least one teammate reminder control of the n teammate reminder controls.

In some embodiments, the interaction module 1440 is configured to switch the main reminder control from an undraggable state to a draggable state in response to a dragging trigger operation for the main reminder control.

In some embodiments, the transmitting module 1460 is configured to perform operation 262 in the embodiment of FIG. 4. The join condition includes at least one of: the teammate virtual character being in a survival state; a distance between the teammate virtual character and the first virtual character being less than a distance threshold; and an attribute of the teammate virtual character being lower than an attribute threshold.

In some embodiments, the display module 1420 is configured to display the n teammate reminder controls around the main reminder control in a surrounding manner.

In some embodiments, the display module 1420 is configured to display the n teammate reminder controls around the main reminder control in the surrounding manner according to a sorting order, where the sorting order includes: an order of sorting by character sequence numbers of the n teammate virtual characters, or an order of sorting by distances between the n teammate virtual characters and the first virtual character, or an order of sorting by attributes of the n teammate virtual characters, or an order of sorting by degrees of intimacy between the n teammate virtual characters and the first virtual character.

In some embodiments, each of the n teammate reminder controls has a size smaller than a size of the main reminder control.

In some embodiments, the interaction module 1440 is configured to adjust the size of the main reminder control to be equal to or smaller than the size of each of the n teammate reminder controls in response to a dragging trigger operation for the main reminder control.

In some embodiments, the n teammate reminder controls are in a one-to-one correspondence with teammate virtual characters in a player's team that meet a join condition; and the join condition includes at least one of:
the teammate virtual character being in a survival state; a distance between the teammate virtual character and the first virtual character being less than a distance threshold; and an attribute of the teammate virtual character being lower than an attribute threshold.

In some embodiments, the display module 1420 is configured to: before the teammate virtual character becomes the transfer target of the team transfer skill, display the teammate reminder control corresponding to the teammate virtual character in a first stat. The display module 1420 is configured to perform operation 270 in the embodiment of FIG. 11. When the apparatus provided in the foregoing embodiments implements its functions, the division of the foregoing functional modules is merely used as an example. In the practical application, the foregoing functions may be allocated to and completed by different functional modules as required. To be specific, an internal structure of a device is divided into different functional modules to complete all or some of the functions described above. In addition, the apparatus provided in the foregoing embodiments belongs to the same conception as the method embodiments. For a specific implementation process, a reference is made to the method embodiments, and details are not described herein again.

FIG. 15 illustrates a structural block diagram of a computer device provided by one embodiment of this application.

The computer device 700 may be a portable mobile terminal, which is also referred to as a mobile terminal in the present embodiment, such as a smart phone, a tablet computer, a moving picture experts group audio layer III (MP3) player, or a moving picture experts group audio layer IV (MP4) player. The computer device 700 may alternatively be referred to as user equipment, a portable terminal, or the like

Generally, the computer device 700 includes a processor 701 and a memory 702.

The processor 701 may include one or more processing cores, for example, a 4-core processor or an 8-core processor. The processor 701 may be implemented in at least one hardware form of a digital signal processor (DSP), a field-programmable gate array (FPGA), and a programmable logic array (PLA). The processor 701 may include a main processor and a coprocessor. The main processor is a processor configured to process data in an awake state, and is also referred to as a central processing unit (CPU). The coprocessor is a low power consumption processor configured to process the data in a standby state. In some embodiments, the processor 701 may be integrated with a graphics processing unit (GPU). The GPU is configured to render and draw content that needs to be displayed on a display screen. In some embodiments, the processor 701 may further include an artificial intelligence (AI) processor. The AI processor is configured to process computing operations related to machine learning.

The memory 702 may include one or more computer-readable storage media. The computer-readable storage media may be tangible and non-transient. The memory 702 may further include a high-speed random access memory and a nonvolatile memory, for example, one or more disk storage devices or flash storage devices. In some embodiments, a non-transitory computer-readable storage medium in the memory 702 is configured to store at least one instruction, and the at least one instruction is configured to be executed by the processor 701, to implement the method for casting a team transfer skill provided in the embodiments of this application.

In some embodiments, the computer device 700 may further include a peripheral device interface 703 and at least one peripheral device. Specifically, the peripheral device includes at least one of a radio frequency (RF) circuit 704, a touch display screen 705, a camera 706, an audio circuit 707, and a power supply 708.

The peripheral interface 703 may be configured to connect the at least one peripheral related to input/output (I/O) to the processor 701 and the memory 702. In some embodiments, the processor 701, the memory 702, and the peripheral device interface 703 are integrated on a same chip or circuit board. In some other embodiments, any one or two of the processor 701, the memory 702, and the peripheral device interface 703 may be implemented on a single chip or circuit board, which is not limited in this embodiment. The RF circuit 704 is configured to receive and transmit an RF signal, also referred to as an electromagnetic signal. The RF circuit 704 communicates with a communication network and other communication devices through the electromagnetic signal. The RF circuit 704 may further include a circuit related to near field communication (NFC). The touch display screen 705 is configured to display a user interface (UI). The UI may include a graph, a text, an icon, a video, and any combination thereof. The camera component 706 is configured to capture images or videos. In one embodiment, the camera component 706 includes a front-facing camera and a rear-facing camera. The audio circuit 707 is configured to provide an audio interface between a user and the computer device 700. The audio circuit 707 may include a microphone and a speaker. The microphone is configured to acquire sound waves of the user and an environment, and convert the sound waves into an electrical signal to input to the processor 701 for processing, or input to the RF circuit 704 for implementing voice communication. The power supply 708 is configured to supply power to the components in the computer device 700. The power supply 708 may be an alternating current, a direct current, a disposable battery, or a rechargeable battery.

In some embodiments, the computer device 700 further includes one or more sensors 709. The one or more sensors 709 include, but are not limited to, an acceleration sensor 710, a gyroscope sensor 711, a pressure sensor 712, an optical sensor 713, and a proximity sensor 714. The acceleration sensor 710 may detect magnitudes of accelerations on three coordinate axes of a coordinate system established with the computer device 700. The gyroscope sensor 711 may detect a body direction and a rotation angle of the computer device 700. The gyroscope sensor 711 may cooperate with the acceleration sensor 710 to collect a three-dimensional (3D) action by the user on the computer device 700. The pressure sensor 712 may be disposed at a side frame of the computer device 700 and/or a lower layer of the touch display screen 705. The pressure sensor is configured to detect a signal of holding the computer device 700 by a user, and/or control an operable control on the UI based on a pressure operation by the user on the touch display screen 705. The optical sensor 713 is configured to acquire ambient light intensity. The proximity sensor 714, also referred to as a distance sensor, is generally disposed on a front side of the computer device 700. The proximity sensor 714 is configured to collect a distance between the user and the front side of the computer device 700.

A person skilled in the art may understand that the structure shown in FIG. 15 does not constitute any limitation on the computer device 700, and the computer device may include more components or fewer components than those shown in the figure, or some components may be combined, or a different component deployment may be used.

In an embodiment, this application provides a chip. The chip includes a programmable logic circuit and/or program instructions. When the chip runs on a computer device, the chip is configured to implement the method for casting a team transfer skill provided by the foregoing method embodiments.

This application provides a computer-readable storage medium, having a computer program stored therein. The computer program is loaded and executed by a processor to implement the method for casting a team transfer skill provided by the foregoing method embodiments.

This application provides a computer program product or a computer program. The computer program product or the computer program includes computer instructions which are stored in a computer-readable storage medium. A processor of a computer device reads the computer instructions from the computer-readable storage medium, and executes the computer instructions, so that the processor of the computer device loads and executes the method for casting a team transfer skill provided by the foregoing method embodiments.

The sequence numbers of the foregoing embodiments of this application are merely for description purposes but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The aforementioned computer-readable storage medium may be a read-only memory, a magnetic disk, an optical disc, or the like.

A person skilled in the art may be aware that in the foregoing one or more examples, the functions described in the embodiments of this application may be implemented by using hardware, software, firmware, or any combination thereof. When implemented by using software, the functions can be stored in a computer-readable medium or can be used as one or more instructions or code on the computer-readable medium for transmission. The computer-readable medium includes a computer storage medium and a communication medium. The communication medium includes any medium that enables a computer program to be transmitted from one place to another. The storage medium may be any available medium accessible to a general-purpose or special-purpose computer. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A method for casting a team transfer skill performed by a computer device, the method comprising:
displaying a first virtual character in a virtual environment;
initiating a reminder control for the team transfer skill in response to a cast operation for the team transfer skill by a user of the computer device, wherein the team transfer skill enables the first virtual character to transfer an associated skill to a teammate virtual character;
transmitting reminder information to at least one teammate virtual character in response to a trigger operation for the reminder control, the reminder information being configured for reminding the at least one teammate virtual character to become a transfer target of the team transfer skill; and
casting the team transfer skill to a second virtual character meeting a transfer condition of the team transfer skill, the second virtual character being a teammate virtual character that becomes the transfer target of the team transfer skill.

2. The method according to claim 1, wherein the reminder control comprises n teammate reminder controls that are in a one-to-one correspondence with n teammate virtual characters, n being a positive integer; and
the transmitting reminder information to at least one teammate virtual character in response to a trigger operation for the reminder control comprises:
transmitting the reminder information to a teammate virtual character corresponding to at least one teammate reminder control in response to a trigger operation for the at least one teammate reminder control of the n teammate reminder controls.

3. The method according to claim 2, wherein the reminder control further comprises a main reminder control; and
the transmitting the reminder information to a teammate virtual character corresponding to at least one teammate reminder control in response to a trigger operation for the at least one teammate reminder control of the n teammate reminder controls comprises:
transmitting the reminder information to the teammate virtual character corresponding to the at least one teammate reminder control in response to a drag operation of dragging the main reminder control onto the at least one teammate reminder control of the n teammate reminder controls.

4. The method according to claim 3, further comprising:
switching the main reminder control from an undraggable state to a draggable state in response to a dragging trigger operation for the main reminder control.

5. The method according to claim 3, further comprising:
adjusting a size of the main reminder control to be equal to or less than a size of each of the n teammate reminder controls in response to a dragging trigger operation for the main reminder control.

6. The method according to claim 3, wherein the reminder control further comprises a main reminder control; and
the transmitting the reminder information to a teammate virtual character corresponding to at least one teammate reminder control in response to a trigger operation for the at least one teammate reminder control of the n teammate reminder controls comprises:
transmitting the reminder information to all teammate virtual characters meeting a join condition in response to the trigger operation for the main reminder control, the join condition comprising at least one of:
the teammate virtual character being in a survival state;
a distance between the teammate virtual character and the first virtual character being less than a distance threshold; and
an attribute of the teammate virtual character being lower than an attribute threshold.

7. The method according to claim 6, wherein the n teammate reminder controls are in a one-to-one correspondence with teammate virtual characters in a player's team that meet a join condition; and the join condition comprises at least one of:
the teammate virtual character being in a survival state;
the distance between the teammate virtual character and the first virtual character being less than the distance threshold; and
the attribute of the teammate virtual character being lower than the attribute threshold.

8. The method according to claim 3, further comprising:
displaying the n teammate reminder controls around the main reminder control in a surrounding manner.

9. The method according to claim 2, further comprising:
displaying a teammate reminder control corresponding to a teammate virtual character in a first state before the teammate virtual character becomes the transfer target of the team transfer skill; and
displaying a teammate reminder control corresponding to the second virtual character in a second state after the second virtual character becomes the transfer target of the team transfer skill.

10. A computer device, comprising a processor and a memory, the memory having a computer program stored therein, and the computer program, when being loaded and executed by the processor, causing the computer device to implement a method for casting a team transfer skill including:
displaying a first virtual character in a virtual environment;
initiating a reminder control for the team transfer skill in response to a cast operation for the team transfer skill by a user of the computer device, wherein the team transfer skill enables the first virtual character to transfer an associated skill to a teammate virtual character;
transmitting reminder information to at least one teammate virtual character in response to a trigger operation for the reminder control, the reminder information being configured for reminding the at least one teammate virtual character to become a transfer target of the team transfer skill; and
casting the team transfer skill to a second virtual character meeting a transfer condition of the team transfer skill, the second virtual character being a teammate virtual character that becomes the transfer target of the team transfer skill.

11. The computer device according to claim 10, wherein the reminder control comprises n teammate reminder controls that are in a one-to-one correspondence with n teammate virtual characters, n being a positive integer; and
the transmitting reminder information to at least one teammate virtual character in response to a trigger operation for the reminder control comprises:
transmitting the reminder information to a teammate virtual character corresponding to at least one teammate reminder control in response to a trigger operation for the at least one teammate reminder control of the n teammate reminder controls.

12. The computer device according to claim 11, wherein the reminder control further comprises a main reminder control; and
the transmitting the reminder information to a teammate virtual character corresponding to at least one teammate reminder control in response to a trigger operation for the at least one teammate reminder control of the n teammate reminder controls comprises:
transmitting the reminder information to the teammate virtual character corresponding to the at least one teammate reminder control in response to a drag operation of dragging the main reminder control onto the at least one teammate reminder control of the n teammate reminder controls.

13. The computer device according to claim 12, wherein the method further comprises:
switching the main reminder control from an undraggable state to a draggable state in response to a dragging trigger operation for the main reminder control.

14. The computer device according to claim 12, wherein the method further comprises:
adjusting a size of the main reminder control to be equal to or less than a size of each of the n teammate reminder controls in response to a dragging trigger operation for the main reminder control.

15. The computer device according to claim 12, wherein the reminder control further comprises a main reminder control; and
the transmitting the reminder information to a teammate virtual character corresponding to at least one teammate reminder control in response to a trigger operation for the at least one teammate reminder control of the n teammate reminder controls comprises:
transmitting the reminder information to all teammate virtual characters meeting a join condition in response to the trigger operation for the main reminder control, the join condition comprising at least one of:
the teammate virtual character being in a survival state;
a distance between the teammate virtual character and the first virtual character being less than a distance threshold; and
an attribute of the teammate virtual character being lower than an attribute threshold.

16. The computer device according to claim 15, wherein the n teammate reminder controls are in a one-to-one correspondence with teammate virtual characters in a player's team that meet a join condition; and the join condition comprises at least one of:
the teammate virtual character being in a survival state;
the distance between the teammate virtual character and the first virtual character being less than the distance threshold; and
the attribute of the teammate virtual character being lower than the attribute threshold.

17. The computer device according to claim 12, wherein the method further comprises:
displaying the n teammate reminder controls around the main reminder control in a surrounding manner.

18. The computer device according to claim 11, wherein the method further comprises:
displaying a teammate reminder control corresponding to a teammate virtual character in a first state before the teammate virtual character becomes the transfer target of the team transfer skill; and
displaying a teammate reminder control corresponding to the second virtual character in a second state after the second virtual character becomes the transfer target of the team transfer skill.

19. A non-transitory computer-readable storage medium, having a computer program stored therein, the computer program, when executed by a processor of a computer device, causing the computer device to implement a method for casting a team transfer skill including:
displaying a first virtual character in a virtual environment;
initiating a reminder control for the team transfer skill in response to a cast operation for the team transfer skill by a user of the computer device, wherein the team transfer skill enables the first virtual character to transfer an associated skill to a teammate virtual character;
transmitting reminder information to at least one teammate virtual character in response to a trigger operation for the reminder control, the reminder information being configured for reminding the at least one teammate virtual character to become a transfer target of the team transfer skill; and
casting the team transfer skill to a second virtual character meeting a transfer condition of the team transfer skill, the second virtual character being a teammate virtual character that becomes the transfer target of the team transfer skill.

20. The non-transitory computer-readable storage medium according to claim 19, wherein the reminder control comprises n teammate reminder controls that are in a one-to-one correspondence with n teammate virtual characters, n being a positive integer; and
the transmitting reminder information to at least one teammate virtual character in response to a trigger operation for the reminder control comprises:
transmitting the reminder information to a teammate virtual character corresponding to at least one teammate reminder control in response to a trigger operation for the at least one teammate reminder control of the n teammate reminder controls.
